(19) United States
(12) Patent Application Publication
(10) Pub. No.: US 2005/0005823 A1
(43) Pub. Date: Jan. 13, 2005

(54) Particulate additive for dispersing admixtures in hydraulic cements

(76) Inventors: John Terry Gourley, Mount Eliza (AU); Christopher John Busck, Beecroft (AU); Paul Gerard McCormick, Nedlands (AU); Nathan Jeremy Chapman, Karrinyup (AU); Gregory Balfour Johnson, Bangor (AU)

Correspondence Address: SMITH, GAMBRELL & RUSSELL, LLP, SUITE 800, 1850 M STREET, N.W., WASHINGTON, DC, 20036, US

(21) Appl. No.: 10/852,663

(22) Filed: May 25, 2004

(30) Foreign Application Priority Data
Nov. 30, 2001 (AU) PR9234
Nov. 30, 2001 (AU) PR9235

(51) Int. Cl. C04B 40/00

(52) U.S. Cl. 106/819; 106/708; 106/790; 106/811

(57) ABSTRACT

The invention relates to a particular additive and method for dispersing an admixture in a cementitious composition comprising a hydraulic cement, to provide activation of the admixture on mixing of the cementitious composition with water wherein the particles of the particulate additive comprise a carrier comprising pozzolanic material and an admixture bound to the particulate carrier wherein the particles of the additive have a median particle size of between one tenth and one half of the median particle size of the cement used in the cementitious composition.

The present invention relates generally to an additive for dispersing admixtures in hydraulic cements, to a cementitious composition containing the additive and to methods and compositions for dispersing admixtures in such cements.

### BACKGROUND

The core components of mortar and concrete are cement or a cementitious binder and aggregates such as sand and stone, and water. Additives such as fly ash and lime are frequently incorporated in cementitious binders. Admixtures such as water reducing agents, air-entraining agents and set modifiers, are frequently added to mortar and concrete. The normal preparation sequence is that the dry, solid components are blended, then the liquid components are added and then the two classes of component are mixed intimately. More specifically, the concrete mixer is started, the sand and stone are added, followed by the binder, water and any admixtures. The binder components, such as cement and fly ash, may be added separately. In some cases, such as with the so-called “dry-batch” method of making premix concrete, different sequences may be used, for various practical reasons. The concrete is mixed for typically 1-6 minutes, depending on the nature of the mixer and of the concrete and then used to make concrete products. In the case of premix concrete, the concrete may be mixed for a much longer period before use.

Admixtures are used to modify the properties of fresh or hardened mortar and concrete. They do this typically by acting upon all or any of the solid phase, specifically the binder particles, the liquid phase, specifically the water, and the interactions between these phases. They are high-leverage components, normally used in small quantities relative to the phase or phases upon which they act. For example, the typical dosage of a common rheological aid is between 0.4% and 0.8% by mass of cement. In order to facilitate dispensing and dispersion, admixtures are commonly supplied as a concentrated aqueous solution—for example, the aforementioned rheological aid is typically supplied as an aqueous solution with a solids content of 40% by mass. Admixtures are normally added towards the end of the mixing process described above.

In order for admixtures to function effectively, they must be properly dispersed at both the macro-level, the level of the sand or aggregate particle and above and the micro-level, the level at which they act.

Admixtures are normally by far the most expensive component of mortar or concrete, on a per unit mass or volume basis.

The mixing processes typically used in the concrete industry are of relatively low efficiency in terms of dispersion at the micro-level. It is known, for example, that when mixed with water, the cement or binder particles, due to surface tension effects, form lumps that are 10 to 30 times the diameter of a cement grain. These lumps may not be broken up with conventional mixers. When admixtures are added in the normal way they cannot penetrate these lumps, cannot act upon the cement or other binder particles within them and cannot therefore function properly. Effectively, the admixture is not fully dispersed at the micro-level.

It is also known, for example, that smaller particles such as silica fume, due to interparticle attractive forces known as Van der Waal's forces, form lumps that are not fully broken up even with intensive mixing. When admixtures such as the above mentioned rheological aid, that act by dispersing small particles, or by preventing such particles from flocculating, are added in the normal way, even if they are able to penetrate such lumps, they cannot act fully upon the particles within them, because the attractive forces are too strong, and cannot therefore function properly.

If concrete is not mixed for sufficient time, there is a risk that an admixture may not be dispersed even at the macro-level. In either case, the admixture will not be able to function effectively.

One mitigation technique is to mix the binder, water and admixtures in a high-shear mixer before blending them with the sand and stone in a conventional mixer. This is technically effective as far as the first category of lump is concerned, but it entails an extra process step and extra capital equipment A variation on this technique is to supply very fine binder components such as silica fume in the form of a slurry. This is technically effective as far as the second category of lump is concerned but involves extra off-site processing and capital equipment and extra on-site capital equipment.

Another mitigation technique is to pre-dilute an admixture in the water that is mixed with the binder, sand and stone to make concrete. However, the quantity of water that is needed for this purpose varies from batch to batch, whereas the quantity of admixture is needed does not which means that the admixture cannot be pre-diluted in the full amount of water that is needed. This introduces another source of non-uniformity. Also, some admixtures, such as the rheological aid mentioned above, even if added in this way, are prematurely and selectively adsorbed onto the cement grains, which impairs their effectiveness. Adding such admixtures after the water is added and the cement grains have been wetted mitigates this, but it lengthens the mixing cycle considerably. In premixed concrete, as opposed to manufactured concrete, this difficulty can be dealt with by adding the admixture on-site, but this reduces the level of control over both the accuracy of admixture dosing and mixing time. Furthermore, neither technique mitigates the problem of binder lump formation.

A common mitigation technique is simply to add an excess of admixture. However, if the mixing process is non-uniform at the macro-level—the problem will be aggravated. Further, this does not mitigate the problem of binder lump formation.

Many admixtures have negative effects when used to excess. For example, the rheological aid cited above, if used to excess, retards the rate at which cement hydrates. A metallic alkali, if used to excess, can cause an expansive reaction with certain types of sand or stone, which can cause concrete to crack. A general overdose may endanger a structure. An excessive localised concentration can impair the local performance of concrete to the point that it endangers a structure.

There is a further practical issue involving the use of admixtures. Some of them, such as metallic alkalis, are hazardous when used in concentrated form. It is not always easy to handle such materials in the conditions that are common to the construction industry and this makes them difficult to use in batching concrete.

An aim of a first aspect of the present invention is to provide improvements to admixtures and their use in hydraulic cements. A particular aim is to provide an improved additive and method for dispersing an admixture within a cementitious composition to improve the handling and/or effectiveness of the admixture.

### SUMMARY OF THE INVENTION

In one aspect the present invention relates to a particulate additive for dispersing an admixture in a cementitious composition comprising a hydraulic cement, to provide activation of the admixture on mixing of the cementitious composition with water wherein the particles of the particulate additive comprise a carrier comprising a pozzolanic material and an admixture bound to the carrier wherein the particles of the additive have a median particle size of between one tenth and one half, preferably one tenth to one third of the median particle size of the cement used in the cementitious composition.

In another aspect the present invention relates to a method of dispersing an admixture through a cementitious composition, comprising a hydraulic cement the admixture being operative to influence the cementitious composition on mixing of the cementitious composition with water the method comprising the steps of; forming a particulate additive by bonding the admixture to a particulate carrier comprising a pozzolanic material wherein the particles of the additive have a median particle size of between one tenth and one half, preferably one tenth to one third of the median particle size of the cement used in the cementitious composition to form a particulate additive and dispersing the particulate additive through the cementitious composition, whereby in use, the admixture is operative to be released from the carrier on mixing of water with the cementitious composition incorporating the dispersed particulate additive.

In a further aspect, the present invention relates to a hydraulic cement binder including a hydraulic cement, and a particulate additive, wherein the particles of the particulate additive comprise a carrier consisting of a pozzolanic material and an admixture bound to the surface of the particulate carrier wherein the particles of the additive have a median particle size of between one tenth and one half, preferably one tenth to one third of the median particle size of the cement used in the cementitious composition.

### DETAILED DESCRIPTION OF THE INVENTION

The specification uses a number of terms that are in general use in the cement and concrete industry. Where used herein the following terms have the meanings ascribed.

A hydraulic cement is a powdered material which, when mixed with water, sets (hardens) to produce a solid material.

A binder is a composition of hydraulic cement and other powdered materials of a similar or finer size. Usually defined as that combination of dry solid particles in the total composition that pass through a 75-micrometer sieve.

A paste is a composition of a binder and water, mixed intimately.

Concrete is a solid mass formed by parts growing or sticking together. The term concrete is commonly used to refer to a composition containing a binder, sand (fine aggregate) and stone (coarse aggregate). The term mortar is commonly used to refer to a similar composition not containing coarse aggregate. The term concrete is herein taken to include both mortar and concrete in its more specific sense.

Rheology is the study of the viscous properties of a fluid as a function of shear strain rate. The aim of this science is to establish relationships between shear stress and shear strain rate. The minimum shear stress that is needed to produce a finite shear strain rate is called the yield stress. The ratio of shear stress to shear strain rate is called the viscosity. Fluids such as water and honey have no finite yield strength but finite viscosity and are called Newtonian fluids. Fluids such as whipped cream; fresh cement paste and fresh concrete have finite yield strength and finite viscosity and are called Bingham fluids. Stiff concretes cannot be described quantitatively using standard rheological tests, but rheological and soil mechanics concepts can be used together to provide a useful qualitative understanding of their behaviour. The rheological properties of cement paste, mortar and concrete have a determining effect on processing costs.

Hydraulic cements include both ordinary and blended Portland cement, slag cement and high alumina cement. Ordinary and blended Portland Cements are the preferred cements for use in the present invention.

Binder refers to components including cementitious (e.g. Portland cement), supplementary cementitious (e.g. pozzolans such as fly ash, silica fume, natural pozzolans and processed natural materials such as metakaolin), or non-reactive such as limestone, aggregate fines and pigments. It is now known that some apparently non-reactive siliceous or calcareous materials, such as crystalline silica and limestone, when finely ground, for example to a particle size in the order of 5 microns or less, react, in the presence of water with any or all of cement, with components of the cement, or with hydration products, notably calcium hydroxide, to produce either an accelerating effect or a supplementary cementitious effect or both so these distinctions have become blurred in recent times. The cement typically forms the major part of the binder. All binder components other than cementitious ones are defined as additives.

A pozzolan is defined as a siliceous or siliceous and aluminous material which in itself possesses little or no cementitious value but will, in finely divided form and in the presence of water, react with calcium hydroxide at ordinary temperature to form compounds possessing cementitious properties. Pozzolans include industrial by-products such as fly ash, condensed silica fume, and blast furnace slag, natural materials such as diatomaceous earth, volcanic ashes, opaline chertz shales and zeolites and modified natural materials such as metakaolin. In the light of the above comments, the term pozzolan is herein taken to include materials, in finely divided form, that contain crystalline silica such as quartz, silica sand, rock dust and the like.

Additives are materials incorporated into the binder to influence all or any of, the rheological properties of the paste, the hydration reaction, the pozzolanic reaction, or the properties of the hardened concrete. Additives are typically powders with a particle size similar to or less than that of cement. They may be used to dilute or extend the paste, to densify the binder, to control the yield strength or viscosity of the paste, to control the rate of release of heat during the hydration reaction, to control the rate of setting or hardening of concrete, to increase the strength or durability of concrete and the like.

Admixtures are materials incorporated into the fresh paste to influence all or any of the rheological properties of the fresh paste, the hydration reaction, the pozzolanic reaction, or the properties of the hardened concrete. Admixtures are conventionally (but not necessarily) formulated as aqueous mixtures. They may be used to control the yield strength or viscosity of the paste, to control the rate of release of heat during the hydration reaction, to control the rate of setting or hardening of concrete, to enhance the bond between aggregate particles and the paste, to densify the transition zone between aggregate particles and the paste, to inhibit the corrosion of reinforcing steel, to increase the strength or durability of concrete, to modify the interaction between the cementitious composition and any other inclusions such as wire, mesh, mat, strands or fibres, to modify the nature or diffusion rates of any materials that may infiltrate the cementitious composition at a later date and the like.

Aggregates are typically inert materials. They may be light or normal-weight. Typical normal-weight aggregates include natural sand and gravel, crushed gravel or crushed rock. Lightweight aggregate can be made from artificial materials, such as expanded polystyrene beads, natural materials, such as scoria or pumice or processed natural materials, such as expanded clay, vermiculite or shale.

The present invention employs two primary mechanisms; dilution, and location, to disperse admixtures within cementitious compositions. Admixtures are first diluted within and bonded to a particulate carrier, to form an additive. The additive is then diluted within the cement, to form a binder. The binder is in turn diluted within the sand and aggregate water is added and the whole composition is mixed to form a cementitious composition in which the admixture is fully dispersed. This sequence is considered by the inventors to be that which will give the most effective dispersion of the admixture, but other sequences may be used without nullifying the advantages of the invention.

The median particle size of the particulate additive is in the range one tenth to one half, preferably one tenth to one third, of the median particle size of the cement in the binder. Most preferably the mean particle size is in the range from one fifth to one third of the mean particle size of the cement. For example, for cement with a median particle size of 12 μm, the particles of the composition would have a median size in the range of 1.2 to 4 μm and preferably from 2.4 to 4 μm. For cement with a median particle size of 10 μm, the median particle size of the particles of the composition would have a median size in the range of 1 to 3.3 μm and preferably from 2 to 3.3 μm. This enables the additive particles to locate in the void space between the cement particles of the binder, thus both locating the admixture and densifying the binder. Location of the admixture improves or facilitates access of the admixture to the phase upon which it acts. Densification of the binder improves or facilitates the improvement of all or any of the rheological properties of the paste, the rate of gain of strength of the concrete and the properties of the hardened concrete. This permits a larger volume of carrier to be used relative to the cement than would otherwise be the case. This improves the dilution of the admixture within the binder and hence the dispersion within the cementitious composition.

The median particle size of the particulate additive and the cement which are used to determine the physical relationships between them referred to herein have for practical reasons, been determined using laser diffraction particle size analysis of an aqueous slurry. It will be appreciated that in an aqueous slurry part or all of the admixture component in the additive may be removed from the additive by becoming detached or dissolved from the surface of the carrier. Thus, strictly speaking this means that the determination will be conducted on particles more closely reflecting the carrier component of the additive. However in practical terms the effect of the admixture component (which is typically a minor component of the carrier for example 0.5% by mass) on the size of carrier particles (which have typically a median size in the order of 4 microns) is not significant and is generally less than the level of detection of equipment used commercially for laser particle size measurement in a slurry.

The median size of the additive particles should not be too low as very fine particles such as silica fume will tend to stick to the surface of the cement particles thereby impairing the Theological properties of the paste and will tend to stick to each other thus increasing their effective size and preventing them from being located and dispersed between the cement particles and from having an optimal effect on all or any of the rheological properties of the paste, the hydration reaction, the pozzolanic reaction and the properties of the hardened concrete.

The size distribution of the additive particles is preferably chosen to complement that of the cement particles so as to permit an optimal combination of packing density and particle size distribution in the binder, in terms of all or any of the Theological properties of the paste, the rate of gain of strength of the concrete and the properties of the hardened concrete. It is not possible to precisely define the particle size distribution of the additive that is optimal for this purpose because the particle size distribution of cements varies, however it may be stated by way of illustration, that if the ratio of median particle sizes of additive and cement is within the preferred range stated above, and if the particle size distribution of the cement is skewed or narrow, which is often the case, then a particle size distribution in the additive that is approximately normal and relatively broad will tend to permit the desired combination to be approximated, for reasons that will be apparent to those skilled in the art. This permits an even larger volume of carrier to be used relative to the cement than would otherwise be the case. This further improves the dispersion of the admixture within the cementitious composition and frequently enables a further reduction in the dosage of such admixtures.

The method of the invention has substantial practical benefit. The method combines the dispersing, locating, and densifying properties of the carrier with the various properties of the admixture that is carried into the binder along with the carrier. In this coupled form, the admixture can be placed where it is most effective, thus reducing the risk of it being wasted, or causing unwanted effects on the general cement hydration process, such as may occur when added in concentrated form directly to the cementitious composition. We have found that frequently, the method enables a reduction in the dosage of admixture that would normally be required to produce the same effect upon the cementitious composition.

The carrier component of the particulate additive comprises a pozzolanic material. The pozzolanic material may include a plurality of pozzolans and optionally other materials. The carrier will typically include at least 50% by volume and preferably at least 80% by volume of pozzolanic materials. Possible additional materials which may be present in the carrier include calcareous materials. These are preferably present in amounts up to 20% by volume. When finely ground, the carrier reacts, in the presence of water with any or all of cement, with components of the cement, or with hydration products, notably calcium hydroxide, to produce either a set accelerating effect or an additional binding effect or both. This permits a larger volume of carrier to be used relative to the cement than would otherwise be the case. This further improves the dispersion of the admixture within the cementitious composition and frequently enables a further reduction in the dosage of such admixtures.

The admixture is a component of the particulate additive and is operative to interact with the carrier particles, other binder particles particularly the cement, or the water phase of the cementitious composition on mixing of the cementitious composition with water. The admixture may be used in this way to influence all or any of, the rheological properties of the fresh paste, the hydration reaction, the pozzolanic reaction or the properties of the hardened concrete. The admixture is water dispersible or water soluble.

Suitable compounds that control the rheological properties of the paste include water reducers such as lignosulfonates, high range water reducers (also called superplasticisers) such as sulfonated melamine formaldehyde condensates and sulfonated naphthalene-formaldehyde condensates, viscosity-enhancers such as weland gum, propylene carbonate and cellulose ethers, and surfactants (including air entraining admixtures) such as stearates and vinsol resin. The admixture component of the invention may include one or more compounds to provide water-reducing normal set, set regarding, set accelerating, water reducing and set retarding or water reducing and set accelerating admixtures. Such admixtures may comprise one or more compounds. Combinations with high range water reducers may also be used to provide normal, retarded or accelerated setting characteristics. The retarding effect of lignosulfonates may for example be reduced by removing associated sugars and/or by including a mild accelerator such as triethanolamine in combination therewith.

Suitable admixtures that control the hydration reaction include set-modifiers (ie set accelerators and set retarders). Suitable set accelerators include sodium and potassium salts of counter ions selected from the group consisting of nitrite, formate, thiocyanate, silicate, aluminate, fluoride and sulfate; calcium chloride, nitrite, nitrate, aluminate and formate; aluminium chloride; triethanolamine and the like. Suitable cement set retarders are generally those compounds which form a chelate with calcium. Specific examples of retarders include sugar, carbohydrate derivatives, hydroxycarboxylic acids, lignosulfonates such as calcium lignosulfonate and sodium lignosulfonate, organic phosphonates such as aminotri(methylene phosphonic acid) and its salts, soluble zinc salts, soluble borates; and the like.

Suitable admixtures that enhance the pozzolanic reaction include alkali metal hydroxides, carbonates and the like (the net effect of this class of admixture is to accelerate setting and hardening and they can equally well be classified as set accelerators)

Suitable steel corrosion inhibitors include alkali metal nitrites, fluorides, phosphates, and benzoates. Further this class of admixtures may include vapour phase inhibitors.

Suitable alkali-aggregate-reactivity inhibitors include lithium salts.

Suitable complexing agents include alkali metal nitrites.

The method of the invention may be used to introduce combinations of admixtures to a cementitious composition. Also, the method of the invention may be used in conjunction with conventional methods or other methods known to those skilled in the art to introduce admixtures to a cementitious composition.

The admixture may be operative to be released from the carrier immediately after or soon after adding water to the binder. In alternative form, the admixture may be designed so that it is released in a controlled manner during formation of the cementitious composition. This may be achieved by absorbing the admixture into the carrier structure, or by including an outer slow release slowly water soluble membrane coating the particulate composition, or through modifying the solubility characteristics of the admixture or the like.

The proportion of the admixture to carrier will depend on the potency of the particular admixture, the desired result in the cementitious composition to be prepared and the proportion of carrier to cement or binder. These interactions are complex but as a general rule it may be said that if the admixture is designed to affect the pozzolanic reaction, the determining relationship will tend to be that between admixture and the pozzolanic component of the carrier and the proportion of admixture to carrier will be determined by the proportion of carrier to cement If the admixture is designed to affect the hydration reaction, the determining relationship will tend to be that between admixture and cement and the proportion of admixture to carrier will be determined by the proportion of carrier to cement. If the admixture is designed to affect the rheological properties of the paste the determining relationship will tend to be that between admixture and binder, and the proportion of admixture to carrier will be determined by the proportion of carrier to binder. In any of these cases, typically the totality of admixtures will comprise between 0.5% and 5% by mass of the carrier.

Typically and preferably the carrier forms a substantial part of the binder. In this way the carrier is operative to facilitate dispersion of the admixture within the cementitious composition by providing maximum dilution of the admixture before mixing the additive with the binder and mixing the cementitious composition with water. We have found that when the cement has a relatively narrow particle size distribution, the median particle size of the carrier is in the order of ⅓that of the cement and the particle size distribution of the carrier is approximately normal and relatively broad, the proportion of carrier to cement that provides both the optimal packing density and particle size distribution of the binder and thus optimal rheological properties of the paste and properties of the hardened concrete, is in the order of 40% by volume. The proportion of the carrier to binder that can be used in practice will depend on the physical and chemical nature of the carrier, the physical and chemical nature of the cement, the potency of the admixture and the desired result in the binder to be prepared. We have found that typically the carrier will comprise between 15% and 50% by volume of cement.

The nature of the bond between the admixture and the carrier may be physical, chemical or electrical, or by any two or all three. In one form, the admixture is coated on the carrier. The coating may be a complete envelope or extend over only part of the surface. In one form, the admixture may be discrete from the carrier while still being bonded to it.

The process by which the admixture is bound to the carrier may be by any suitable means including mechanical milling, immersion and drying, fluidised bed coating and the like. We have found, however that the composition of the invention is particularly effective when the additive of the invention is prepared by mechanically milling a carrier with a dry admixture or with an admixture in liquid form when the quantity of solvent is sufficiently low to evaporate during the milling process. We have found this process to be flexible and efficient; it provides a means of adjusting both the median size and size distribution of the carrier particles (if such be necessary) and results in the admixture becoming securely bonded to the carrier particles. The expression “mechanical mill” is to be understood to include ball mills, nutating mills, tower mills, planetary mills, vibratory mills, attrition mills, gravity dependent type ball mills, jet mills, rod mills, high pressure grinding mills and the like. By way of example, a ball mill is a vessel that contains grinding media that are kept in a state of continuous relative motion by input of mechanical energy. The grinding media are typically steel or ceramic balls. Sufficient energy is imparted to the particles within a ball mill by ball-particle-ball and ball-particle-mill collisions to cause attrition of the admixture, attrition and/or abrasion of the carrier particles and bonding of the admixture to the carrier.

Without wishing to be bound by theory we believe that the preferred nature of bonding is physical rather than chemical or electrical and this enables the admixture to release more effectively when dispersed in a cementitious composition.

Techniques that involve immersion and drying are feasible, but have some limitations. For example, porous carriers such as metakaolin or zeolites can be immersed in a liquid admixture such as sodium nitrite, and then dried to retain the anhydrous admixture within the surface or body pores. However these techniques require an additional process step. Also, some admixtures, such as metallic alkali hydroxides and salts, may react with the carrier or with each other during the bonding process rather than during the hydration reaction (or the pozzolanic reaction) and thus not achieve, or not fully achieve, their intended purpose.

It is to be understood that normally not all the admixture will be fully bonded to the carrier by the above processes and a minor amount of it may be loosely dispersed in the carrier.

It is particularly preferred in the preparation of the additive of the invention that the admixture is bonded to the carrier by co-milling of these components. It is particularly preferred that the admixture be in the form of a dry solid or a concentrated solution that evaporates during the milling process as this provides superior results both in achieving bonding and in the performance of the concrete. Milling is preferably carried out using a stirred attritor mill or a ball mill. The grinding media used in the attritor mill or ball mill preferably have a diameter between 2 and 5 millimeters and the peripheral speed of the stirring arms is typically between 2 and 10 metres/second. Internal temperature of the mill is typically not more than 250 degrees celsius and preferably not more than 100 degrees celsius. We have found that at high temperature some admixtures will react with the carrier or degrade in such a way as to impair their release or functionality.

In a further aspect, the present invention provides a particulate composition that is designed to be used in any form of the method described above.

In a preferred form, the carrier is a pozzolan or a plurality of pozzolans and the additive is prepared by cogrinding the carrier with the admixture in the form of a dry solid or a concentrated solution that evaporates during the milling process, in an attritor or ball mill, to provide a carrier with a median particle size in the range referred to above, and a particle size distribution that provides optimal packing density and particle size distribution of the binder, and to bond the admixture to the carrier. In a particularly preferred form, the carrier is fly ash. Milling is preferably conducted without added water.

In another preferred form, the carrier is a plurality of pozzolans and consists of a majority of fly ash and a minority of very fine particles such as silica fume or metakaolin and the additive is prepared as above.

In another preferred form, the carrier is composed of a majority of a pozzolan or pozzolans and a minority of calcareous materials; and the additive is prepared by co-grinding the carrier with an admixture or admixtures as above. In a particularly preferred form, the pozzolan is fly ash and the calcareous material is calcium carbonate.

In another preferred form, the carrier and coating process are as above and the carrier particles are coated with at least one admixture, herein referred to as the base admixture, which is operative to enhance the pozzolanic reaction together with one or more of the other admixtures described above. The base admixture compensates either partially or fully for the retardation of the setting and hardening process that happens when cement is replaced with additives that are not by themselves cementitious. This permits a larger volume of carrier to be used relative to the cement. This further improves or facilitates the improvement of both the densification of the binder and the dispersion of other admixtures that may be bonded to the carrier, within the cementitious composition. In a particularly preferred form, the base admixture is sodium hydroxide and/or carbonate, which are thought to enhance the pozzolanic reaction. The use of sodium compounds for the base admixture or admixtures is advantageous, as they are inexpensive and easy to bond to siliceous carriers such as fly ash.

In another preferred form the carrier and coating process are as above and the carrier particles are coated with a base admixture as above, and other admixtures are added in conventional fashion to the cementitious composition at the time of mixing. In a particularly preferred form, the base admixture is sodium hydroxide and/or carbonate, which are thought to enhance the pozzolanic reaction.

These arrangements have substantial practical benefit in that by combining a carrier composed of particles of appropriate composition, size and size distribution, with an admixture or admixtures, to form a particulate additive, the effectiveness of both the carrier and the admixture or admixtures in influencing the properties of the resulting cementitious composition can be improved.

In a further preferred embodiment the invention provides a binder composition for use in preparing concrete the binder comprising a hydraulic cement and a particulate additive of the invention wherein the ratio of carrier to cement is in the range of 15 to 50% by volume and preferably 25 to 40% by volume. The binder may include additional components of the type generally known in the art for use in binders for example silica fume. It should be noted when used in conjunction with the method of the inventions less silica fume will be needed to achieve a given effect than would otherwise be the case. It should also be noted that normally it would be preferable to include the silica fume in the additive (rather than separately in the binder) so as to take advantage of the locating and dispersing advantages of the method of the invention.

The invention also provides a method of making concrete comprising providing a binder component comprising the particulate additive and hydraulic cement, and possibly other binder components such as silica fume, combining the binder with sand, aggregate, and water and mixing the composition to form fresh concrete.

The method of the invention has substantial practical benefit. The method combines the locating, dispersing, and densifying properties of the carrier with the various properties of the admixture that is carried into the binder along with the carrier. In this coupled form, an admixture can be placed where it is most effective, and dispersed most efficiently, thus reducing the risk of it being wasted, or causing unwanted effects on the general cement hydration process, such as may occur when added to the cementitious composition in concentrated form, during the mixing process.

By using a predominantly pozzolanic carrier of optimal particle size and size distribution, a relatively large quantity of carrier can be used and the admixture can be significantly diluted before the additive is added to the cement or the cementitious composition. This has the advantage of reducing the risk of non-uniformity that can occur when small quantities of an admixture are added to large quantities of cementitious composition and mixed for a relatively short time with the mixing processes that are normally used in mixing concrete.

This invention also reduces the risk of danger to personnel when caustic or hazardous admixtures are used.

Bonding the admixture to the carrier has the significant advantage that it eliminates the risk of segregation of the admixture during storage, handling or dispersion thus guaranteeing even dispersion in the carrier and facilitating precise location in the cementitious composition

It also enables minimum dosage of admixture, by optimising its efficacy by both improved dispersion and location of the admixture and by densification of the binder (which frequently reduces the need for many admixtures), thus reducing the risk of deleterious effects of the admixture that may happen through overdose. For example, we have found that the preferred dosage of alkali metal hydroxide in terms of early age strength of concrete is generally from 0.1 to 2%, preferably 0.1 to 1% and more preferably about 0.5% by mass of carrier, compared with JP 7-351469, which describes a method of activating fly ash for mixing with concrete, such method characterised in that up to 5% alkaline salt solids are added during the preparation of finely ground fly ash. This is a very high level of alkaline salt solids and would not be acceptable in many codes of practice.

Dispersing a water-soluble admixture within a carrier and bonding the admixture to the carrier helps water penetrate the lumps of binder that form before or during mixing. It thus helps the break up of lumps thereby improving dispersion both of the binder and of the admixture during mixing.

Including finer particles such as silica fume in the carrier and subjecting them to the process of the invention, mitigates the clumping of such particles that tends to occur when handled, batched and mixed by conventional means, enables the admixture to act more effectively upon such particles and enables the particles themselves to function more effectively.

The additive of the present invention has a median particle size in the range of from one tenth to one half of the median particle size of the cement, preferably from one tenth to one third and most preferably from one fifth to one third the median particle size of the cement component. The particle size referred to is determined by laser diffraction of an aqueous suspension of the additive using commercially available equipment such as the Malvern Masterizer 2000 available from Malvern Instruments Ltd. (www.malvem.co.uk).

It will be appreciated by those skilled in the art that water soluble admixtures will be at least partly removed in forming an aqueous suspension: thus, strictly speaking this means that the determination will be conducted on particles more closely reflecting the carder component of the additive. However in practical terms the effect of the admixture component (which is typically a minor component of the carrier for example 0.5% by mass) on the size of carrier particles (which have typically a median size in the order of 4 microns) is not significant and is generally less than the level of detection of equipment used commercially for laser particle size measurement in a slurry.

It is convenient to hereinafter describe embodiments of the present invention with reference to the following examples. It is to be appreciated that the particularity of the examples in its related description is to be understood as not superseding the generality of the preceding broad description of the invention.

### EXAMPLE 1

In this example, a range of admixtures was dry milled with a range of carriers in an attritor mill within the preferred operating parameters described earlier in this specification, to reduce the median particle size of the carrier, adjust its size distribution so as to be approximately normal and relatively broad, dilute the admixture within the carrier and bond it to the carrier. X-ray Photoelectron Spectroscopy (XPS) analysis, coupled with Scanning Electron Microscopy (SEM) analysis, was carried out on the additives so formed. This showed that that the surface of the carrier particles was rich in admixture compared with the body of the carrier particles and that the admixture could not be present in loosely dispersed form. The SEM analyses showed that the hypothesis of uniform coating of individual carrier particles was not realistic and a more complicated scenario is likely, with particles of admixture being lodged in the surface of agglomerates, and attached to individual carrier particles in some cases. Some of the additive could be lodged within agglomerates of carrier particles. Consistent with this, as much as 90% of the admixture could be washed from the carrier using deionised water at room temperature. The results of these tests are shows in Table 1.

TABLE 1

| | | | | Surface mass | Surface mass |
|---|---|---|---|---|---|
| | | Median | | concentration | concentration |
| Sample | | particle | | of Na wt % as | of Na wt % after |
| No | Carrier | size μ | Additive | received | washing |
| 140 | ″ | 3.0 | 0.5% Na₂SO₄ | 5.0 | 1.2 |
| 141 | ″ | 3.3 | 1% PSF10* | 3.6 | 1.0 |
| 142 | ″ | 3.0 | 0.5% Na₂CO₃ | 7.4 | 2.0 |
| 143 | ″ | 3.1 | 0.5% Na₂SO₄ | 8.2 | 1.6 |
| | | | 0.5% Na₂CO₃ | | |
| 152 | ″ | 3.7 | 0.5% Na₂SO₄ | 3.7 | 0.4 |
| | | | 1% PSF10 | | |
| 153 | ″ | 3.2 | 0.5% Na₂CO₃ | 8.2 | 1.0 |
| | | | 1% PSMF10 | | |
| 148 | ″ | 3.1 | 0.5% Na₂SO₄ | 3.2 | 0.7 |
| 149 | ″ | 2.8 | 1% PSF10 | 1.5 | 0.9 |
| 151 | 95% fly ash | 3.4 | 0.5% Na₂SO₄ | 3.8 | 1.4 |
| | 5% CaCO₃ | | | | |

*PerimenPSMF10, a melamine sulphonate formaldehyde based superplasticiser, used in dry powder form. The sodium content of Perimen is given by the manufacturer as <13% Na₂O.

These results show that it is possible, using the method of the invent7ion, to bond a range of admixtures to and release them from a range of carriers. The results also show that the specific admixtures were bonded to the carrier by physical rather than chemical means, were not altered significantly by the method of the invention, and could be expected to perform normally in cementitious compositions. Further, the results indicate that the method of the invention can be expected to work with most admixtures.

### EXAMPLE 2

In this example, the additive was made by dry milling fine class F fly ash with a median particle size of 15 microns in an attritor mill within the preferred operating parameters described earlier in this specification, to reduce the median particle size of the fly ash to 4 microns and adjust its size distribution so as to be approximately normal and relatively broad. No admixture was used. When the additive was used in the binder of a conventional slump concrete, while holding slump constant at 100 mm, the effect was to reduce water demand while increasing strength. The results of this trial are shown in Table 2.

TABLE 2

| | | Early age strength (Mpa) | | | Later age |
|---|---|---|---|---|---|
| | Concrete | 340° C. hrs* | 410° C. hrs* | 480° C. hrs* | strength (Mpa) |
| Mix | water % | (maturity) | (maturity) | (maturity) | 7 days** |
| 13%*** fly ash | 6.8 | 28.5 | 34.75 | 35.0 | 50.75 |
| 20% additive | 6.4 | 32.25 | 36.25 | 42.5 | 63.25 |

*steam cured at 65° C.
**water cured at 20° C.
***binder consists of 87 wt % cement and 13 wt % fly ash

A similar trial was carried out with a similar mix, but with the water-binder ratio held constant at 0.33. The control mix had 16% of fly ash by mass of cement and the trial mix had 24% of additive by mass of cement. The effect was to increase slump from 70 mm to 100 mm while increasing both early and later age strengths by between 25 and 50%.

This shows that the method of the invention makes it possible to use an increased proportion of carrier with respect to cement in slump concrete.

### EXAMPLE 3

In this example, the additive was made by dry milling fine class F fly ash with a median particle size of 15 microns and 1% by mass of anhydrous sodium sulphate in an attritor mill within the preferred operating parameters described earlier in this specification, to reduce the median particle size of the fly ash to 4 microns and adjust its size distribution so as to be approximately normal and relatively broad, dilute the admixture within the carrier and bond it to the carrier particles. The proportion of sodium sulphate to fly ash had been shown in prior tests to be higher than optimum in respect of rate of gain of early strength of mortar.

The 28-day compressive strengths of mortars made with sand, cement (median particle size of 12.5 microns), additive and water (with a water/binder ratio of 0.48, and a total binder content of 25% by mass of total dry mix components) are given in Table 3.

TABLE 3

| | 28 day |
|---|---|
| | Water Cured Concrete Cylinder |
| Mix | Compressive Strength (MPa) |
| 27.8%* unmilled fly ash | 56.0 |
| 27.8% milled fly ash (no admixture) | 62.5 |
| 27.8% additive (milled fly ash + 1% | 64.5 |
| sodium sulphate) | |

*of total binder (cement + fly ash), by mass.

This shows that the admixture of the example functions normally or to advantage in mortar, after having been subjected to the method of the invention.

### EXAMPLE 4

In this example, the additive was made by dry milling fine class F fly ash with a median particle size of 15 microns and 0.5% by mass of anhydrous sodium hydroxide in an attritor mill within the preferred operating parameters described earlier in this specification, to reduce the median particle size of the fly ash to 4 microns and adjust its size contribution so as to be approximately normal and relatively broad, dilute the sodium hydroxide within the carrier and bond it to the carrier particles. The proportion of sodium hydroxide to fly ash had been shown in earlier tests to be an optimum in respect of rate of gain of early strength of concrete.

The effect of the additive of this example in mortar was assessed using Australian Standard 3583.6—1995, Methods of test for supplementary cementitious materials for use with Portland cement, Method 6: Determination of relative water requirement and relative strength.

In this test, a control mortar is prepared using the amount of water required to give a specified flow. The control mortar is prepared using a selected Portland cement without addition of additive, plus sand. A test mortar having the same flow is prepared and the relative water requirement is calculated from the ratio of water additions for the respective mixes. The test mortar is prepared using a mixture of the additive and the Portland cement used for the control mortar plus the same quantity of the sand used for the control mortar. Compressive strength determinations are performed on prismatic specimens made from control and test mortars prepared in the same manner as for determination of the relative water requirement.

When the additive as above was used to make a test mortar and subjected to the above test, the effect was to reduce relative water demand and increase relative strength. The median particle size of the cement was 12.5 microns. Results are shown in Table 4.

TABLE 4

| | | | | Relative water | Relative |
|---|---|---|---|---|---|
| Mix | Cement G | Additive g | Sand g | demand % | strength % |
| Control | 450 | 0 | 1350 | 100 | 100 |
| Test | 300 | 150 | 1350 | 95 | 106 |

This shows that the admixture of the example functions normally or to advantage in mortar, after having been subjected to the method of the invention.

When the additive as above was used in concrete the effect was to increase both early and later age compressive strength. Results are shown in Table 5. For comparison, results from identical trials using conventional fine class F fly ash (median particle size of 15 microns), and milled fine class F fly ash (median particle size of 4 microns) as the additive are included. All mixtures were made using no-slump concrete with a free water/binder ratio of 0.31 and a total binder content of 14.3% by mass of total dry materials. The median particle size of the cement was 12.5 microns.

TABLE 5

| | Early age cylinder | | Later age | |
|---|---|---|---|---|
| | compressive strength (Mpa) | | cylinder compressive | |
| Mix | 100° C. hrs* | 300° C. hrs* | strength (Mpa) | |
| Curing regime | (maturity) | (maturity) | 7 days** | 28 days** |
| 15%*** fly ash | 12.0 | 30.0 | 50.5 | 58.5 |
| 15% milled fly ash | 11.5 | 34.0 | 51.0 | 63.5 |
| 15% additive | 15.5 | 39.5 | 62.5 | 70.0 |
| 33% milled fly ash | 6.0 | 29.5 | 54.0 | 61.0 |
| 33% additive | 10.5 | 34.5 | 62.0 | 74.0 |

*steam cured at 65° C.
**cured in water at 20° C.
***binder consists of 85 wt % Portland cement + 15 wt % fly ash.

There are no standard rheological tests for no slump concrete but in factory trials in the manufacture of concrete products by the so-called “dry cast” method, the additive as above, when used in the ratio of 35% by mass of a cement having a median particle size of 12.5 microns, in the mix shown in table 5, was shown to improve the Theological properties of fresh concrete, relative to the mix containing 15% normal fly ash shown in Table 5, resulting in a measured 50% reduction in rejects and defects, and an estimated 10% improvement in productivity.

This shows that the admixture of the example functions normally or to advantage in no slump concrete, after having been subjected to the method of the invention. It also shows that the method of the invention it makes it possible to use an increased proportion of carrier with respect to cement in no-slump concrete. It also shows that the method enables significant economies in admixture use compared with at least one example of prior art, JP 7-351469, which describes a method of activating fly ash for mixing with concrete, which uses examples in which 5% alkaline salt solids are added during the preparation of finely ground fly ash.

Finally, it is to be appreciated that various alterations, modifications and/or additions may be introduced into the methods or compositions previously described without departing from the spirit or ambit of the present invention.

1. A particulate additive for dispersing an admixture in a cementitious composition comprising a hydraulic cement, to provide activation of the admixture on mixing of the cementitious composition with water wherein the particles of the particulate additive comprise a carrier comprising pozzolanic material and an admixture bound to the particulate carrier wherein the particles of the additive have a median particle size of between one tenth and one half of the median particle size of the cement used in the cementitious composition.

2. A particulate additive according to claim 1 wherein the median particle size of the additive is from one tenth to one third of the median particle size of the cement.

3. A particulate additive according to claim 1 wherein the median particle size of the additive is in the range of one fifth to one third of the median particle size of the cement.

4. A particulate additive according to claim 1 wherein the particle size distribution of the additive is approximately normal.

5. A particulate additive according to claim 2 wherein the carrier comprises at least 50% by volume of pozzolanic material.

6. A particulate additive according to claim 2 wherein the carrier comprising pozzolanic materials in an amount of at least 80% by volume of the carrier component and calcareous material in an amount of up to 20% by volume of the carrier.

7. A particulate additive according to claim 5 wherein the pozzolanic material is fly ash.

8. A particulate additive according to claim 6 wherein the admixture is a water dispersible solid.

9. A particulate additive according to claim 2 wherein the admixture is selected from the group consisting of rheological property modifiers, set modifiers, and admixtures which modify the properties of the hardened concrete.

10. A particulate additive according to claim 2 wherein the admixture is selected from the group consisting of water reducers, high range water reducers, set retarders, set accelerators, and mixtures of two or more thereof.

11. A particulate additive according to claim 2 wherein the admixture is selected from the group consisting of surfactants including air entraining agents.

12. A particulate additive according to claim 2 wherein the admixture is selected from the group consisting of admixtures that enhance the pozzolanic reaction.

13. A particulate additive according to claim 2 wherein the admixture is present in an amount in the range of from 0.5 to 5% by weight of the carrier.

14. A particulate additive according to claim 2 wherein the admixture is bound to the carrier by a method of mechanically milling the carrier with the admixture.

15. A particulate additive according to claim 14 wherein the carrier is milled with the admixture in the absence of added water.

16. A cementitious composition comprising a binder comprising hydraulic cement and an additive according to claim 2.

17. A cementitious composition according to claim 13 wherein the carrier is present in an amount of from 15 to 50% by volume of the hydraulic cement component.

18. A method of dispersing an admixture through a cementitious composition, comprising a hydraulic cement the admixture being operative to influence the cementitious composition on mixing of the cementitious composition with water the method comprising the steps of; forming a particulate additive by bonding the admixture to a particulate carrier comprising a pozzolanic material wherein the particles of the additive have a median particle size of between one tenth to one third of the median particle size of the cement used in the cementitious composition to form a particulate additive and dispersing the particulate additive through the cementitious composition, whereby in use, the admixture is operative to be released from the carrier on mixing of water with the cementitious composition incorporating the dispersed particulate additive.

19. A method according to claim 18 wherein the particulate additive is formed by co-milling the carrier and admixture.

20. A method according to claim 19 wherein the co-milling is carried out without added water in an attritor mill or ball mill.

21. A method according to claim 18 wherein the carrier comprises at least 50% by volume of pozzolanic material.

22. A method according to claim 18 wherein the admixture is present in an amount of from 0.5 to 5% by weight of the carrier and the additive is present in an amount of from 15 to 50% by volume of hydraulic cement.
